(19) United States
(12) Patent Application Publication
(10) Pub. No.: US 2002/0119237 A1
(43) Pub. Date: Aug. 29, 2002

(54) Medium and method for delivery of edible materials subject to degradation by oxidation and hydrolysis

(76) Inventor: Maurice O. Hevey, Minneapolis, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/025,037

(22) Filed: Dec. 19, 2001

Related U.S. Application Data
(60) Provisional application No. 60/257,668, filed on Dec. 22, 2000.

(51) Int. Cl. A23D 7/00

(52) U.S. Cl. 426/601

(57) ABSTRACT

A palatable viscous carrier for delivery of a variety of ingestible substances including dietary supplements, therapeutic agents, vitamins, and other probiotic agents. In addition, the present invention protects components from contact with atmospheric oxygen and water that may degrade their quality. The present invention also provides a natural oil coating to protect the ingestible substances from degradation by stomach acids. Furthermore, the vehicle, herein described, is easily dispensed using inexpensive, commonly available packaging such as collapsible tubes, two compartment aerosols, and pump dispensers. The vehicle of the present invention is an anhydrous, hydrophobic, nontoxic vegetable oil base that can be made using commonly used manufacturing equipment. The invention is directed primarily to veterinary applications, but also has applications in any industry involving the delivery of nutritional supplements and probiotic agents to living creatures.

### CLAIM TO PRIORITY

The present application claims priority to United States Provisional Patent Application No. 60/257,668, filed Dec. 22, 2000, and entitled “Pet Supplement.” The identified provisional patent application is hereby incorporated by reference in its entirety.

### FIELD OF THE INVENTION

The present invention relates to carriers and vehicles for supplying therapeutic agents, dietary supplements, and the like to humans and animals. More particularly, it relates to a viscous carrier for these substances that is palatable and protects the carried agents from degradation.

### BACKGROUND OF THE INVENTION

The use of nutritional supplements by has become popular. Many people ingest them. It is also common in the veterinary, animal keeping, and animal husbandry industries to feed nutritional supplements and medications to animals. The number and variety of such substances is large and growing. They come in a variety of forms and combinations. Substances may be in solid, liquid, granular, and powdered forms. This leads to a large variety of material handling needs.

The activity and potency of many ingestible substances are degraded by exposure to atmospheric oxygen and water and stomach acid. The substances of greatest interest to the veterinary community are dietary supplements, therapeutic and non-therapeutic materials, extracts, compounds, and blends thereof. Examples of these materials include freeze-dried microorganisms, ascorbic acid, certain enzymes such as Papain, salts of bioactive ingredients such as glucosamine hydrochloride, glucosamine sulfate, and chondroitin sulfate, polysaccharides and mixtures thereof.

When exposed to water, many of these compounds hydrolyzed or are otherwise rendered chemically inactive. When these materials are exposed to atmospheric oxygen, they may be oxidized and chemically modified. The net result is loss of activity and potency. In the case of dietary supplements and therapeutic agents, the beneficial qualities of the agents are reduced. Particularly, the medicinal effects of therapeutic agents may be partially or completely lost. The pharmacological value to the person or animal that needs the full potency of these beneficial ingredients is lost or diminished. This results in unnecessary suffering or at least lowered quality of life.

In addition, when ingested, ingestible substances must pass through the stomach. Stomach acid has a pH sufficiently low to degrade many agents that one may wish to introduce in to the gastrointestinal tract. Further, the stomach kills most probiotic bacteria that are exposed to stomach acid. Thus, before an agent can be absorbed in the intestinal tract it must survive the chemically hostile stomach environment.

Exposure to stomach acids destroys at least part of the active ingredient resulting in less entering the small and large intestine where absorption of these agents takes place. The net result is loss of beneficial activity and/or potency. In the case of dry dietary supplements and therapeutic agents, the pharmacological value to the person or animal that needs the full potency of these beneficial ingredients is lost or diminished.

Traditional methods of protecting compounds that are subject to hydrolysis and or oxidization have mostly relied on packaging solutions to separate the compounds from ubiquitous oxygen and water. Surrounding vulnerable compounds with an inert atmosphere is a related option. Dry nitrogen, for example, is inert and displaces oxygen and water. Vacuum packaging attempts to remove as much of the offending substances as possible. However, some volatile substances do not lend themselves to vacuum approaches. The volatile compounds will tend to evaporate and be removed along with the air and moisture.

U.S. Pat. No. 6,171,632 issued to Lanter et al., discloses a solid gel product formed into a diamond shape to create what are, in essence, synthetic fish for the feeding of aquatic birds and mammals. The composition of matter is intended to eliminate the problems associated with providing, keeping, and handling the quantities of fresh or frozen fish that form the primary diet of carnivorous aquatic warm blooded creatures in captivity.

In any case, all these approaches rely on the integrity of a containing package. The use of sealed containers provides excellent protection so long as the containers remain sealed. As soon as the package is opened, atmospheric air and moisture are reintroduced and the processes that lead to degradation begin again. This problem can be addressed, in part, by using single dose packaging but single dose packaging is expensive and environmentally questionable. Beyond that, the need to open a new package for each dose is time consuming and inconvenient. This is particularly true when there are a variety of dosage sizes needed.

Anti-oxidant agents can be added to mixtures to slow the oxidation process. The addition of anti-oxidant agents helps to protect ingredients that are subject to oxidation. This method of protection against oxidation is usually temporary and affords no protection against loss of potency due to moisture damage.

Thus, there is a need for a method of protecting the potency and strength of various substances from degradation, from exposure to atmospheric oxygen, and moisture. Protection from stomach acids would be beneficial as well. It would be preferable if the technique would continue to work after the packaging was opened. It should be inexpensive and environmentally nondestructive. In addition, it would be helpful if the product was easily and conveniently dispensed. It would be further beneficial if these various substances could be provided in a uniform medium.

### SUMMARY OF THE INVENTION

The present invention solves most of the above problems by providing a palatable viscous carrier for delivery of a variety of ingestible substances including dietary supplements, therapeutic agents, vitamins, and other probiotic agents. In addition, the present invention protects components from contact with atmospheric oxygen and water that may degrade their quality. The present invention also provides a natural oil coating to protect the ingestible substances from degradation by stomach acids. Furthermore, the vehicle herein described, is easily dispensed using inexpensive, commonly available packaging such as collapsible tubes, two compartment aerosols, and pump dispensers. The vehicle of the present invention is an anhydrous, hydrophobic, nontoxic vegetable oil base that can be made using commonly used manufacturing equipment. The invention is directed primarily to veterinary applications but also has applications in any industry involving the delivery of nutritional supplements and probiotic agents to living creatures.

The present invention relates to protecting therapeutic agents, nontherapeutic ingredients, and dietary supplements from oxidation due to exposure to atmospheric oxygen and hydrolysis caused by atmospheric moisture through the use of a hydrophobic gel matrix that can easily be dispensed through a collapsible tube or through a pump delivery system. The present invention also protects these agents from degradation by stomach acid.

The composition of the present invention includes one or more vegetable oils, hydrogenated vegetable oils, one or more fish oils, active ingredients, and other inactive additives.

### DETAILED DESCRIPTION OF THE PREFERRED EMBODIMENTS

The carrier of the present invention generally comprises one or more vegetable oils, hydrogenated vegetable oils, fish oils, antioxidants, and inactive ingredients such as flavorings and colorings. It may be used as a vehicle to deliver active ingredients that are subject to degradation from exposure to oxygen and/or water.

Vegetable oils may include canola oil, hybrid sunflower (helianthus annus) oil, borage seed (borago officinalis) oil, and evening primrose (oenothera biennis) oil and other vegetable oils. Both seed and germ oils may be employed. Other examples include avocado oil, sweet almond oil, canola oil, grape seed oil, jojoba oil, apricot kernal oil, safflower oil, sesame oil, hybrid safflower oil, soybean oil, sunflower seed oil, and macadamia nut oil.

Hydrogenated vegetable oils may be any suitable hydrogenated vegetable oil, however, a preferred hydrogenated vegetable oil is a powder formulation, specifically, Cremeol™ HF-52 spc, which is manufactured by Aarhus Oliefabrik A/S of Denmark.

Fish oils may include any oil of fish origin. Cod liver oil USP is a commonly available oil that can be employed. Other usable fish oils are tuna oil, salmon oil, and sardine oil.

Antioxidants provide additional protection to substances that are subject to oxidation. Antioxidants may include tocopherols. In this application tocopherols is understood to include alpha, beta, gamma, and delta tocopherols. Other ingestible antioxidants may be employed as well.

The inactive additives may include oil soluble flavors, spray-dried flavors, freeze-dried flavors, oil soluble plant extracts derived from the stems, leaves, flowers or seeds of said plant, spray-dried plant extracts derived from the stems, leaves flowers or seeds of said plant, freeze-dried plant extracts derived from the stems, leaves flowers or seeds of said plant, starches and modified starches derived from plants, hydrophobic polyols, coloring agents and/or combinations thereof.

Spray-dried flavors that may be employed include flavor oils and oleoresins that have been encapsulated in protective coatings of modified food starch, maltodextrin, or gum arabic.

Oleoresins are pure extractives of a spice or herb. They are concentrated natural liquid flavorings that contain both volatile (aromatic “top notes”) and non-volatile flavor components. Oleoresins provide flavor profiles characteristic of the ground spice or herb with a more rapid flavor release. Oleoresins are soluble in oil.

Essential oils are concentrated natural flavorings, produced by steam distillation, that consist entirely of the volatile, aromatic “top notes” of a spice or herb. They provide the aroma profile of the ground material, without the non-volatile portion. Essential oils are typically clear in appearance. Essential oils are soluble in oil.

Spray-dried flavors are used extensively in the food industry. They are widely used in powdered spice mixes sold in individual pouches.

Freeze-drying is the process of dehydrating substances under a vacuum so the moisture content changes directly from a solid to a gaseous form without having to undergo the intermediate liquid state through sublimation. In this process, the product maintains its original size and shape with a minimum of cell rupture. Removing moisture prevents a product from deteriorating at room temperature.

The process is used for drying and preserving a number of food products, including meats, vegetables, fruits, and instant coffee products. The dried product will be the same size and shape as the original frozen material and will be found to have excellent stability and convenient reconstitution when placed in water. Freeze-dried products will maintain nutrients, color, flavor, and texture often indistinguishable from the original product. Some freeze-dried foods can be ground up and used as a source of flavors.

Active ingredients include, but are not limited to, those subject to degradation by oxidation, hydrolysis, or acids such as freeze-dried probiotic microorganisms, antibiotics, oil soluble, and water soluble vitamins, enzymes such as Papain, salts of bioactive ingredients such as glucosamine hydrochloride, glucosamine sulfate, and chondroitin sulfate, polysaccharides, fructooligosaccharides, and/or combinations thereof.

Preparation of the present invention proceeds as follows:

Oils and hydrogenated vegetable oil are added to a clean, stainless steel or glass mixing vessel. Using a mixer with a propeller type stirrer attached, the ingredients are mixed and heated to 60° C. (140° F.). Temperature and agitation are continued until any solidified oil has melted and the mixture is clear and homogeneous.

When the batch is clear and homogeneous, constant stirring is continued and any salts of bioactive ingredients are added.

At 40° C., flavor is added with constant stirring. Cooling is continued to 35° C. with stirring, at which point any probiotic bacteria or fructoologosacharrides are added.

With stirring, the mixture is cooled to 25° C. to 30° C. (77° F. to 86° F.) whereby the mixture produced is very thick and ready to be transferred into suitable containers.

Example formulas for carrying out the invention are provided below.

### EXAMPLE 1

The formulation of Example 1 was prepared with reference to the components listed in Table 1.

TABLE 1

| Raw Material | Weight Percent |
|---|---|
| Canola Oil | .001% to 60% |
| Hybrid Sunflower (Helianthus Annus) Oil | .001% to 60% |
| Cod Liver Oil USP | .001% to 60% |
| Tocopherol | .001% to 60% |
| Hydrogenated Vegetable Oil | 9% to 20% |
| (Cremeol HF-52 ™ spc) | |
| Glucosamine Hydrochloride | .001% to 30% |
| Taurine | .001% to 30% |
| Flavor | .1% to 5% |

The preparer placed canola oil, hybrid sunflower (helianthus annus) oil, cod liver oil USP, tocopherol, and hydrogenated vegetable oil into a clean, stainless steel or glass mixing vessel.

Using a mixer with a propeller type stirrer attached, the preparer mixed the ingredients and heated to 60° C. (140° F.). The temperature was maintained and agitation continued as the hydrogenated vegetable oil melted and the mixture became clear and homogeneous.

After the batch became clear and homogeneous, the preparer added the glucosamine hydrochloride and taurine with constant stirring.

At 40° C., the preparer added flavor with constant stirring. Continued cooling to 35° C. with stirring and further cooled mixture to 25° C. to 30° C. (77° F. to 86° F.). The mixture was very thick and ready to be transferred into suitable containers.

The above is a preferred formula and method for dispensing Glucosamine Hydrochloride and Taurine to a cat, specifically an older cat. The benefits of Glucosamine Hydrochloride have been well documented in scientific literature. Taurine is an essential amino acid for cats. Cats cannot synthesize Taurine and must rely on outside sources of supplement. Taurine is not an essential amino acid for humans and, therefore, the formulation of Example 1 is not best suited for humans.

### EXAMPLE 2

The formulation of Example 2 was prepared with components as listed in Table 2.

TABLE 2

| Raw Material | Weight Percent |
|---|---|
| Canola Oil | .001% to 60% |
| Hybrid Sunflower (Helianthus Annus) Oil | .001% to 60% |
| Cod Liver Oil USP | .001% to 60% |
| Tocopherol | .001% to 60% |
| Hydrogenated Vegetable Oil | 9% to 20% |
| (Cremeol HF-52 ™ spc) | |
| Borage (Borago Officinalis) Seed Oil | .001% to 30% |
| Evening Primrose (Oenothera Biennis) Oil | .001% to 30% |
| Papaya Extract | .001% to 30% |
| Flavor | .1% to 5% |
| Fructooligosaccharides | .1% to 15% |
| A blend of one or more probiotic bacteria | total count 10 |
| which may include but is not limited to: | cfu/gram to 50 |
| Lactobacillus acidophilus, Lactobacillus | Billion cfu/gram |
| rhamnosus, Enterococcus faecium, | |
| Lactobacillus helveticus and Lactobacillus | |
| plantarum. | |

The preparer placed canola oil, hybrid sunflower (helianthus annus) oil, cod liver oil USP, tocopherol, hydrogenated vegetable oil, borage (borago officinalis) seed oil, and evening primrose (oenothera biennis) oil into a clean stainless steel or glass mixing vessel.

Using a mixer with a propeller type stirrer attached, the preparer mixed the ingredients and heated to 60° C. (140° F.). The temperature was maintained and agitation continued until the hydrogenated vegetable oil melted and the mixture was clear and homogeneous.

The preparer cooled the mixture to 40° C. with constant stirring.

At 40° C., the preparer added papaya extract and flavor with constant stirring and continued cooling to 35° C. with stirring.

At 35° C., fructooligosaccharides and probiotic bacteria were added.

With stirring, the preparer cooled the mixture to 25° C. to 300° C. (77° F. to 86° F.). The mixture was very thick and ready to be transferred into suitable containers.

This example provides a preferred formula and method of dispensing Omega 3 fatty acids, Omega 6 fatty acids, and probiotic bacteria.

The Omega 3 fatty acids may include Linolenic Acid, Docosahexaenoic Acid, and Eicosapentaenoic Acid, while Omega 6 fatty acids may include Linoleic Acid, Gamma Linolenic Acid, and Eicosapentaenoic Acid.

The benefit of Omega 3 and Omega 6 fatty acids in the diets of humans and pets has been well documented in scientific literature. Since the human body cannot produce Omega 3 and Omega 6 fatty acids, they are essential fatty acids in the human diet which must be delivered by supplement.

Probiotic bacteria are used to promote the good health and well-being of humans and animals of all ages. An older human or a senior animal benefits from this formulation, however, additional benefit may be obtained by adding Glucosamine Hydrochloride and Chondroitin Sulfate as dietary supplements for good joint health.

### EXAMPLE 3

The formulation of Example 3 was prepared with components as listed in Table 3.

TABLE 3

| Raw Material | Weight Percent |
|---|---|
| Canola Oil | .001% to 60% |
| Hybrid Sunflower (Helianthus Annus) Oil | .001% to 60% |
| Cod Liver Oil USP | .001% to 60% |
| Tocopherol | .001% to 60% |
| Hydrogenated Vegetable Oil | 9% to 20% |
| (Cremeol HF-52 ™ spc) | |
| Borage (Borago Officinalis) Seed Oil | .001% to 30% |
| Evening Primrose (Oenothera Biennis) Oil | .001% to 30% |
| Papaya Extract | .001% to 30% |
| Flavor | .1% to 5% |
| Glucosamine Hydrochloride | .001% to 30% |
| Fructooligosaccharides | .1% to 15% |
| A blend of one or more probiotic bacteria | total count 10 |
| which may include but is not limited to: | cfu/gram to 50 |
| Lactobacillus acidophilus, Lactobacillus | Billion cfu/gram |
| rhamnosus, Enterococcus faecium, | |
| Lactobacillus helveticus and Lactobacillus | |
| plantarum. | |

The preparer placed canola oil, hybrid sunflower (helianthus annus) oil, cod liver oil USP, tocopherol, hydrogenated vegetable oil, borage (borago officinalis) seed oil, and evening primrose (oenothera biennis) oil into a clean stainless steel or glass mixing vessel.

Using a mixer with a propeller type stirrer attached, the preparer mixed the ingredients and heated to 60° C. (140° F.). The temperature was maintained and agitation continued until the hydrogenated vegetable oil melted and the mixture was clear and homogeneous.

When the batch was clear and homogeneous, the preparer added, with constant stirring, the glucosamine hydrochloride.

The mixture was then allowed to cool to 40° C. with constant stirring.

At 40°0 C., papaya extract and flavor was added with constant stirring. Cooling was continued to 35°0 C. with stirring.

At 35° C., the preparer added fructooligosaccharides and probiotic bacteria and continued stirring to cool the mixture to 25° C. to 30° C. (77° F. to 86° F.). The mixture was very thick ready to be transferred into suitable containers.

The formulation of Example 3 has all the benefits of Example 2, as described above, but additionally includes the benefits of Glucosamine Hydrochloride and Fructooligosaccharides. Fructooligosaccharides have preferred prebiotic properties for probiotic applications and have been marketed as such in the health food industry. Fructooligosaccharides, through bifidobacteria fermentation, reduces colonic pH, thereby increasing solubility for various mineral salts. Through fructooligosaccharides stimulation of bifidobacteria and suppression of pathogenic bacteria, fructooligosaccharides reduce liver toxins, carcinogens, food intolerances, and provides immune stimulation properties.

### EXAMPLE 4

The formulation of Example 4 was prepared with components as listed in Table 4.

TABLE 4

| Raw Material | Weight Percent |
|---|---|
| Canola Oil | 50.30% |
| Hybrid Sunflower (Helianthus Annus) Oil | 0.20% |
| Cod Liver Oil | 1.00% |
| Tocopherol | 0.25% |
| Hydrogenated Vegetable Oil | 10.00% |
| (Cremeol HF-52 ™ spc) | |
| Glucosamine Hydrochloride | 25.00% |
| Chondroitin Sulfate | 10.00% |
| Lactobacillus acidophilus (and) | 1.00% |
| Lactobacillus rhamnosus (and) | |
| Enterococcus faecium (and) Lactobacillus | |
| helveticus (and) Lactobacillus plantarum | |
| (and) Maltodextrin (and) Ascorbic Acid | |
| Flavor | 2.25% |

The preparer placed canola oil, hybrid sunflower (helianthus annus) oil, cod liver oil USP, tocopherol, and hydrogenated vegetable oil into a clean stainless steel or glass mixing vessel.

Using a mixer with a propeller type stirrer attached, the preparer mixed the ingredients and heated to 60° C. (140°0 F.). Temperature and agitation was maintained until the hydrogenated vegetable oil melted and the mixture was clear and homogeneous.

When the batch was clear and homogeneous, the preparer added, with constant stirring, the glucosamine hydrochloride and chondroitin sulfate.

The mixture was cooled to 40° C. with constant stirring.

At 40° C., the preparer added flavor with constant stirring and cooling continued to 35° C. with stirring.

At 35° C., the preparer added fructooligosaccharides and probiotic bacteria and with continued stirring, cooled the mixture to 25° C. to 30° C. (77° F. to 86° F.). The mixture was thick and ready to be transferred into suitable containers.

A preferred range of concentrations for the components of Example 4 is provided below in Table 5.

TABLE 5

| Component | Preferred Weight Percent |
|---|---|
| Canola Oil | 45% to 55% |
| Hybrid Sunflower (Helianthus Annus) Oil | .1% to 5% |
| Cod Liver Oil USP | 1% to 5% |
| Tocopherol | .25% to 1% |
| Hydrogenated Vegetable Oil | 9% to 12% |
| Glucosamine Hydrochloride | 20% to 30% |
| Taurine | .1% to 5% |
| Flavor | .5% to 2% |

The formulation of Example 4 has the benefits of Example 3, described above, with the additional benefit of Chondroitin Sulfate, which is a component that is important for good joint health in both humans and animals. However, it should be noted that borage (borago officinalis) seed oil and evening primrose (oenothera biennis) oil, which are two sources of Omega 3 and Omega 6 fatty acids, were omitted from this formula potentially reducing the level of these fatty acids within the formulation. Fructooligosaccharides have also been omitted from the formulation.

The present invention may be embodied in other specific forms without departing from the spirit of the essential attributes thereof; therefore, the illustrated embodiments should be considered in all respects as illustrative and not restrictive, reference being made to the appended claims rather than to the foregoing description to indicate the scope of the invention.

What is claimed:

1. A palatable viscous carrier for ingestible substances subject to degradation by environmental factors such as oxidation, hydrolysis, or low pH comprising in weight percent based upon the weight of the palatable viscous carrier:
from 45% to 55% vegetable oil;
from 1% to 5% fish oil; and
from 0.25% to 1.0% exogenous antioxidants.

2. The carrier as claimed in claim 1, in which the vegetable oil comprises one or more substances selected from a group consisting of canola oil, helianthus annus oil, hydrogenated vegetable oil, borage seed oil, evening primrose oil, avocado oil, sweet almond oil, canola oil, grape seed oil, jojoba oil, apricot kernal oil, safflower oil, sesame oil, hybrid safflower oil, soybean oil, sunflower seed oil, and macadamia nut oil.

3. The carrier as claimed in claim 1, in which the fish oil comprises one or more substances selected from a group consisting of cod liver oil, tuna oil, salmon oil, and sardine oil.

4. The carrier as claimed in claim 1, in which the exogenous antioxidant comprises tocopherol.

5. The carrier as claimed in claim 4, in which the tocopherol comprises one or more substances selected from a group consisting of alpha tocopherol, beta tocopherol, gamma tocopherols and delta tocopherols.

6. The carrier as claimed in claim 1, further comprising one or more substances selected from a group consisting of flavoring, plant extracts, starches, hydrophobic polyols, and coloring agents.

7. A palatable probiotic ingestible food supplement in a viscous carrier, the food supplement comprising in weight percent based upon the weight of the palatable probiotic ingestible food supplement:
from 45% to 55% vegetable oil;
from 1% to 5% fish oil; and
from 0.25% to 1.0% exogenous antioxidants; and
from 0.1% to 5% probiotic ingredients.

8. The food supplement as claimed in claim 7, in which the vegetable oil comprises one or more substances selected from a group consisting of canola oil, helianthus annus oil, hydrogenated vegetable oil, borage seed oil, evening primrose oil, avocado oil, sweet almond oil, canola oil, grape seed oil, jojoba oil, apricot kernal oil, safflower oil, sesame oil, hybrid safflower oil, soybean oil, sunflower seed oil, and macadamia nut oil.

9. The food supplement as claimed in claim 7, in which the fish oil comprises one or more substances selected from a group consisting of cod liver oil, tuna oil, salmon oil, and sardine oil.

10. The food supplement as claimed in claim 7, in which the exogenous antioxidant comprises tocopherol.

11. The food supplement as claimed in claim 10, in which the tocopherol comprises one or more substances selected from a group consisting of alpha tocopherol, beta tocopherol, gamma tocopherols, and delta tocopherols.

12. The food supplement as claimed in claim 7, further comprising one or more substances selected from a group consisting of flavoring, plant extracts, starches, hydrophobic polyols, and coloring agents.

13. The food supplement as claimed in claim 7, in which the probiotic ingredients comprise one or more substances selected from a group consisting of freeze-dried probiotic microorganisms, antibiotics, oil soluble, and water soluble vitamins, enzymes, salts of bioactive ingredients and polysacharides.

14. The food supplement as claimed in claim 7, further comprising papain.

15. The food supplement as claimed in claim 17, in which the probiotic ingredients is one or more substances selected from a group consisting glucosamine hydrochloride, glucosamine sulfate, and chondroitin sulfate.

16. The food supplement as claimed in claim 7, further comprising fructooligosaccharides.

17. The food supplement as claimed in claim 7, in which the probiotic ingredients comprise microorganisms.

18. The food supplement as claimed in claim 17, in which the microorganisms comprise one or more selected from a group consisting of lactobacillus acidophilus, lactobacillus rhamnosus, enterococcus faecium, lactobacillus helveticus, and lactobacillus plantarum lactobacillus acidophilus, lactobacillus rhamnosus, and lactobacillus plantarum.

19. A method for delivering probiotic substances utilized in dietary supplements to an intestinal tract, the method comprising the steps of:
heating and mixing natural occurring ingestible oils comprising vegetable oils and fish oils until a resulting mixture is clear and homogeneous;
cooling said resulting mixture to a viscous state and to a temperature that will not harm the probiotic substances;
adding the probiotic substances to the cooled mixture and mixing such that the probiotic substances are coated with the cooled mixture whereby an ingestible, viscous dietary supplement is produced.

20. The method as claimed in claim 19, in which the vegetable oils are selected from a group consisting of canola oil, helianthus annus oil, hydrogenated vegetable oil, borage seed oil, evening primrose oil, avocado oil, sweet almond oil, canola oil, grape seed oil, jojoba oil, apricot kernal oil, safflower oil, sesame oil, hybrid safflower oil, soybean oil, sunflower seed oil, and macadamia nut oil.

21. The method as claimed in claim 19, in which the fish oils comprise one or more substances selected from a group consisting of cod liver oil, tuna oil, salmon oil, and sardine oil.

22. The method as claimed in claim 19, further comprising the step of adding one or more substances selected from a group consisting of flavoring, plant extracts, starches, hydrophobic polyols, and coloring agents.

23. The method as claimed in claim 19, in which the probiotic substances comprise one or more substances selected from a group consisting of freeze-dried probiotic microorganisms, antibiotics, oil soluble, and water soluble vitamins, enzymes, salts of bioactive ingredients, and polysacharides.

24. The method as claimed in claim 19, in which the probiotic substances comprise one or more substances selected from a group consisting glucosamine hydrochloride, glucosamine sulfate, and chondroitin sulfate.

25. The method as claimed in claim 19, in which the probiotic substances comprise one or more microorganisms selected from a group consisting of lactobacillus acidophilus, lactobacillus rhamnosus, enterococcus faecium, lactobacillus helveticus, and lactobacillus plantarum lactobacillus acidophilus, lactobacillus rhamnosus, and lactobacillus plantarum.
